(19) United States
(12) Patent Application Publication
(10) Pub. No.: US 2026/0005436 A1
(43) Pub. Date: Jan. 1, 2026

(54) REFLECTING ELEMENT FOR INTELLIGENT REFLECTING SURFACE

(71) Applicant: Japan Display Inc., Tokyo (JP)

(72) Inventors: Daiichi SUZUKI, Tokyo (JP); Shinichiro OKA, Tokyo (JP); Mitsutaka OKITA, Tokyo (JP); Kazuki MATSUNAGA, Tokyo (JP)

(73) Assignee: Japan Display Inc., Tokyo (JP)

(21) Appl. No.: 19/321,350

(22) Filed: Sep. 8, 2025

Related U.S. Application Data
(63) Continuation of application No. PCT/JP2024/005283, filed on Feb. 15, 2024.

(30) Foreign Application Priority Data
Mar. 15, 2023 (JP) 2023-041002

(51) Int. Cl. H01Q 3/46; H01Q 15/14

(52) U.S. Cl. CPC H01Q 3/46; H01Q 15/148

(57) ABSTRACT

A reflecting element for an intelligent reflecting surface includes a patch electrode including a first opening pattern, a common electrode opposed to and spaced apart from the patch electrode and including a second opening pattern, and a liquid crystal layer arranged between the patch electrode and the common electrode and containing a liquid crystal molecule and an ultraviolet curable monomer. The first opening pattern overlaps the second opening pattern in a plan view. The liquid crystal layer includes a first region including the liquid crystal molecule and the ultraviolet curable monomer, and a second region including the liquid crystal molecule in a resin polymerized and solidified with the ultraviolet curable monomer.

### CROSS-REFERENCE TO RELATED APPLICATIONS

This application is a Continuation of International Patent Application No. PCT/JP2024/005283, filed on Feb. 15, 2024, which claims the benefit of priority to Japanese Patent Application No. 2023-041002, filed on Mar. 15, 2023, the entire contents of each are incorporated herein by reference.

### FIELD

An embodiment of the present invention relates to the structure of a radio wave reflecting device using a liquid crystal. In this specification, the radio wave reflecting device is also referred to as an “intelligent reflecting surface”, and the radio wave reflecting element constituting the radio wave reflecting device is also referred to as a “reflecting element”.

### BACKGROUND

A phased array antenna controls the directivity of an antenna by adjusting the amplitude and phase of a high-frequency signal applied to each of a plurality of antenna elements arranged in a plane shape. The phased array antenna uses a phase shifter to control the phase of the high-frequency signal. As an example, a phased array antenna device using a phase shifter that utilizes the phenomenon of the dielectric constant of a liquid crystal changing with an applied voltage is disclosed (refer to Japanese laid-open patent publication No. H11-103201).

An Intelligent Reflecting Surface that controls the direction of radio wave reflection using liquid crystals, similar to a phased array antenna, is known. For example, an intelligent reflecting surface that reflects radio waves by forming a meta surface using a microstrip patch array sandwiching a liquid crystal layer is disclosed (refer to Japanese laid-open patent publication No. 2019-530387).

With the spread of fifth-generation mobile communication systems (5G), the application of reflecting elements is being considered to simplify radio base stations. The reflecting elements with a constant dielectric constant have a fixed radio wave reflection direction. On the other hand, as disclosed in Japanese laid-open patent publication No. 2019-530387, the reflecting element using a liquid crystal material as a dielectric can change the reflection direction of radio waves depending on the voltage applied to the liquid crystal.

### SUMMARY

A reflecting element for intelligent reflecting surface in an embodiment according to the present invention includes a patch electrode including a first opening pattern, a common electrode opposed to and spaced apart from the patch electrode and including a second opening pattern, and a liquid crystal layer arranged between the patch electrode and the common electrode and containing a liquid crystal molecule and an ultraviolet curable monomer. The first opening pattern overlaps the second opening pattern in a plan view. The liquid crystal layer includes a first region including the liquid crystal molecule and the ultraviolet curable monomer, and a second region including the liquid crystal molecule in a resin polymerized and solidified with the ultraviolet curable monomer.

### BRIEF DESCRIPTION OF DRAWINGS

FIG. 1A is a plan view of a unit cell of a reflecting element according to an embodiment of the present invention.

FIG. 1B is a cross-sectional view of a unit cell of a reflecting element according to an embodiment of the present invention.

FIG. 2 is a plan view of a unit cell of a reflecting element according to an embodiment of the present invention.

FIG. 3 is a plan view of a unit cell of a reflecting element according to an embodiment of the present invention.

FIG. 4 is a schematic cross-sectional view illustrating the operation of a reflecting element according to an embodiment of the present invention.

FIG. 5 is a plan view of a reflecting element according to an embodiment of the present invention.

FIG. 6 is a plan view of a reflecting element according to an embodiment of the present invention.

FIG. 7 is a cross-sectional view of a unit cell of a reflecting element according to an embodiment of the present invention.

### DESCRIPTION OF EMBODIMENTS

Hereinafter, embodiments of the present invention are described with reference to the drawings. However, the present invention can be implemented in many different aspects and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements similar to those described previously with respect to previous drawings may be given the same reference sign (or a number followed by a, b, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

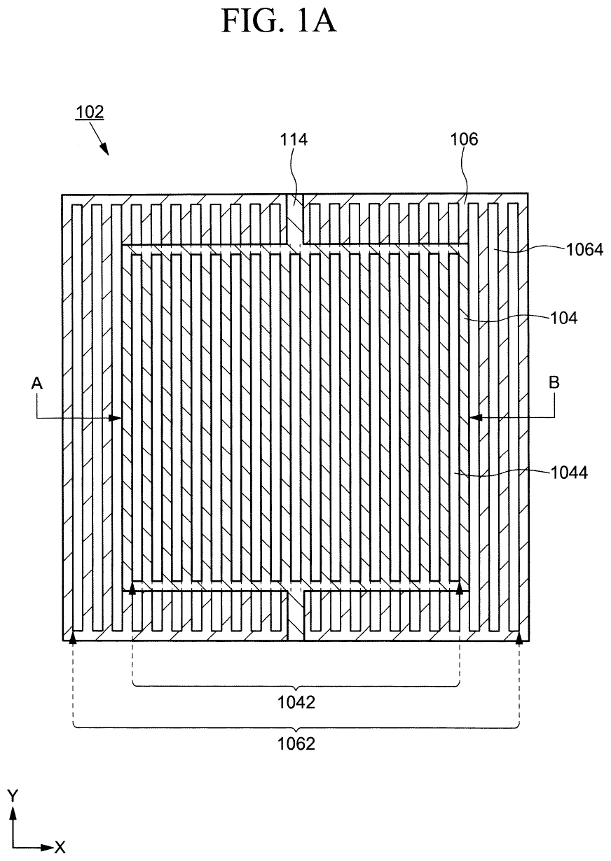

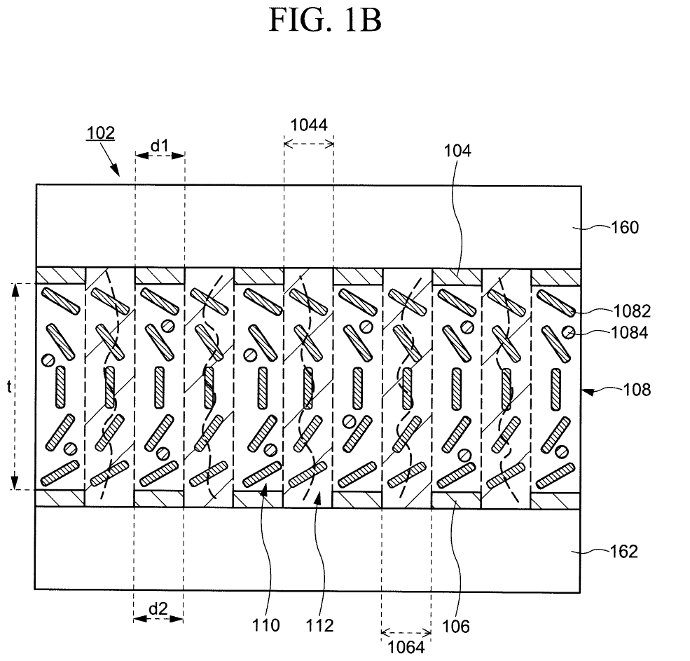

FIG. 1A shows a plan view of a unit cell 102 configured as a reflecting element (radio wave reflecting element) of the intelligent reflecting surface (radio wave reflecting device) according to the present embodiment. The plan view shown in FIG. 1A shows the structure of the unit cell 102 as viewed from the front (the side surface from which radio waves enter the unit cell 102). FIG. 1B shows a cross-sectional view of the unit cell 102 corresponding to the line A-B shown in the plan view.

As shown in FIG. 1A and FIG. 1B, the unit cell 102 includes a patch electrode 104, a common electrode 106, and a liquid crystal layer 108. The patch electrode 104 is arranged on a first substrate 160, and the common electrode 106 is arranged on a second substrate 162. Although not shown in the figure, a first alignment film may be arranged on the first substrate 160 to cover the patch electrode 104, and a second alignment film may be arranged on the second substrate 162 to cover the common electrode 106. The patch electrode 104 and the common electrode 106 are arranged to overlap in a plan view. The liquid crystal layer 108 is disposed between the patch electrode 104 and the common electrode 106. The patch electrode 104 is arranged on the side of the liquid crystal layer 108 of the first substrate 160, and the common electrode 106 is arranged on the side of the liquid crystal layer 108 of the second substrate 162.

The patch electrode 104 is preferably shaped to be symmetrical with respect to the polarization of the incident radio wave (vertical or horizontal polarization). The patch electrode 104 typically has a square shape in a plan view, and may be a rectangle, a polygon having more angles than a square, or a circle in consideration of reflection characteristics. FIG. 1A shows an example where the patch electrode 104 is square in a plan view. On the other hand, the common electrode 106 is not limited in shape and is provided in a larger size than the patch electrode 104.

The first substrate 160 may be arranged with a strip wiring 114 connected to the patch electrode 104. The strip wiring 114 is used to connect adjacent unit cells when a plurality of unit cells 102 are arranged. The strip wiring 114 can be used when a control voltage for controlling the alignment state of the liquid crystal molecules 1082 included in the liquid crystal layer 108 is applied to the patch electrode 104.

Although not shown in FIG. 1A and FIG. 1B, the first substrate 160 is bonded to the second substrate 162 by a sealant. The liquid crystal layer 108 is arranged between the first substrate 160 and the second substrate 162 in a region surrounded by a sealant. A gap between the first substrate 160 and the second substrate 162 is 20 μm to 100 μm, for example, 50 μm. The first substrate 160 is arranged with patch electrodes 104, and the second substrate 162 is arranged with common electrodes 106, so that the gap length is, more exactly, the distance between the patch electrodes 104 and the common electrodes 106. However, since a thickness of the patch electrode 104 and the common electrode 106 is 1 μm or less, which is small compared with the gap length, the gap length can be regarded as a distance substantially between the first substrate 160 and the second substrate 162. Although not shown in FIG. 1B, spacers may be arranged between the first substrate 160 and the second substrate 162 to keep the gap length constant.

As members constituting the unit cell 102, the patch electrode 104 and the common electrode 106 are formed of a metal film such as aluminum to reduce resistance. The first substrate 160 and the second substrate 162 are formed of a dielectric material such as glass. The first substrate 160 and the second substrate 162 are preferably transparent so as to be able to transmit light (ultraviolet light) as described below.

When the patch electrode 104 is replaced with a pixel electrode and the common electrode 106 is replaced with a counter electrode, the unit cell 102 has the same structure as a liquid crystal panel used in a display. While a thickness of the liquid crystal layer of the liquid crystal panel (also called “cell gap”) is about 1 μm to 5 μm, the liquid crystal layer 108 of the unit cell 102 has a thickness about 10 times that. The response speed of the liquid crystal decreases as the gap of the liquid crystal cell increases. Therefore, the response speed of the liquid crystal of the unit cell 102 becomes very slow. Here, the response speed refers to a time until the liquid crystal molecules change to an alignment state corresponding to the applied voltage when a predetermined voltage is applied to the liquid crystal. The reflecting element has a configuration in which unit cells are arranged in one or two dimensions, and the unit cell has a structure in which the liquid crystal layer is sandwiched between the patch electrode and the common electrode, therefore, when the operation of the individual unit cells is slow, there is a problem that the time required for controlling the reflection direction of the radio waves increases.

On the other hand, the unit cell 102 according to the present embodiment has a structure in which the liquid crystal layer 108 sandwiched between the patch electrode 104 and the common electrode 106 is divided into a plurality of small cells within the sandwiched region, and the liquid crystal material is confined in a narrow region. It is possible to improve the response speed of the unit cell 102 by having such a configuration.

As shown in FIG. 1A, the patch electrode 104 has a first opening pattern 1042, and the common electrode 106 has a second opening pattern 1062. FIG. 1A shows an embodiment of a first opening pattern 1042 formed by first openings 1044 and a second opening pattern 1062 formed by second openings 1064. The first opening 1044 is a stripe-like pattern in which the opening region extends in the first direction and is arranged at predetermined intervals in the second direction. The second opening 1064 is a stripe-like pattern in which the opening region extends in the first direction and is spaced apart in the second direction. The distance (or pitch) between the first openings 1044 and the second openings 1064 in the second direction is the same.

In this embodiment, the first direction refers to the direction parallel to the Y-axis shown in FIG. 1A, and the second direction refers to the direction parallel to the X-axis shown in FIG. 1A.

The patch electrode 104 and the common electrode 106 are arranged so that the first openings 1044 and the second openings 1064 overlap in a plan view. As shown in FIG. 1B, when the width of the first openings 1044 is d1 and the width of the second openings 1064 is d2, d1 and d2 may have the same size or one width may be larger than the other (d1>d2, d1<d2). Even if the widths of the first openings 1044 and the second openings 1064 vary, it is preferable that the unit cell 102 has a structure in which light is transmitted from one substrate side to the other substrate side when viewed from the first substrate 160 side and from the second substrate 162 side. In other words, when the unit cell 102 is viewed directly from the patch electrode 104 side or from the common electrode 106 side, the back surface can be seen through. In other words, it is possible to make light incident on the liquid crystal layer 108 from the side of the patch electrode 104, and also to make light incident on the liquid crystal layer 108 from the side of the common electrode 106.

A control signal for controlling the alignment of the liquid crystal molecules 1082 of the liquid crystal layer 108 is applied to the patch electrode 104. The control signal is a DC voltage signal or a polarity inversion signal in which a positive DC voltage and a negative DC voltage are alternately reversed. A voltage at an intermediate level of a ground potential or a polarity inversion signal is applied to the common electrode 106. When the control signal is applied to the patch electrode 104, the alignment state of the liquid crystal molecules 1082 included in the liquid crystal layer 108 changes. The dielectric constant of the liquid crystal layer 108 changes according to the change in the alignment state of the liquid crystal molecules 1082. The unit cell 102 can change the dielectric constant of the liquid crystal layer 108 by the control signal applied to the patch electrode 104, thereby changing (delaying) the phase of the reflected wave when reflecting the radio wave.

The liquid crystal layer 108 includes a liquid crystal material containing liquid crystal molecules 1082 and a monomer 1084 (hereinafter referred to as “ultraviolet curable monomer”) crosslinked by ultraviolet rays. The liquid crystal material having dielectric anisotropy is used for the liquid crystal layer 108. For example, nematic liquid crystal, smectic liquid crystal, cholesteric liquid crystal and discotic liquid crystal can be used as the liquid crystal layer 108. The dielectric constant of the liquid crystal layer 108 having dielectric anisotropy is changed by the change of the alignment state of the liquid crystal molecules. The unit cell 102 can change the dielectric constant of the liquid crystal layer 108 by the control signal applied to the patch electrode 104, thereby delaying the phase of the reflected wave as it reflects the radio wave.

The frequency bands covered by the reflecting element are the Very High Frequency (VHF) band, the Ultra-High Frequency (UHF) band, the Super High Frequency (SHF) band, the Tremendously High Frequency (THF) band, the Extra High Frequency (EHF) band, and the Terahertz band. The alignment of the liquid crystal molecules 1082 of the liquid crystal layer 108 is changed by the control signal applied to the patch electrode 104. However, it does not substantially follow the frequency of the radio wave incident on the patch electrode 104. As a result of these characteristics of the liquid crystal molecule 1082, it is possible to reflect radio waves while changing the dielectric constant of the liquid crystal layer 108 by the patch electrode 104, and to control the phase of the reflected radio waves.

A type of material using a radical polymerization of unsaturated double bonds such as acrylic or a material using a cationic polymerization such as epoxy can be used as the ultraviolet curable monomer 1084.

The liquid crystal layer 108 can also be distinguished into a first region 110 and a second region 112. The first region 110 is a region where a region other than the first openings 1044 of the patch electrode 104 and a region other than the second openings 1064 of the common electrode 106 overlap. The second region 112 is a region where the first openings 1044 of the patch electrode 104 and the second openings 1064 of the common electrode 106 overlap. The first region 110 includes the liquid crystal molecule 1082 and the ultraviolet curable monomer 1084, and the second region 112 includes the liquid crystal molecule 1082 in a resin 1122 in which the ultraviolet curable monomer is polymerized (by ultraviolet irradiation) and solidified. In other words, the first region 110 is a region in which the alignment state of the liquid crystal molecules 1082 can be changed by an electric field generated between the patch electrode 104 and the common electrode 106 and may be called an alignment control region. The second region 112 is a region in which the liquid crystal molecules 1082 are fixed in the resin 1122 and may be called a region of the resin wall because it is formed along the stripe-like first openings 1044 and the stripe-like second openings 1064.

As will be apparent with reference to FIG. 1A and FIG. 1B, the first region 110 where the alignment of the liquid crystal molecules 1082 are controlled is sandwiched between the second region 112 where a resin wall is formed. From this shape, it can be assumed that a plurality of elongated liquid crystal cells is formed in the region where the patch electrode 104 and the common electrode 106 overlap. As described above, when an electric field is applied between the patch electrode 104 and the common electrode 106, the alignment state of the liquid crystal molecules 1082 in the first region 110 (liquid crystal cell) changes, while the liquid crystal molecules 1082 in the second region 112 are fixed in the resin, and the alignment state does not change even when the electric field is applied, or the alignment state hardly changes.

A width (length in the short direction) of the stripe-shaped first openings 1044 and the stripe-like second openings 1064 is about 3 μm to 10 μm, for example, 5 μm. This width is sufficiently small for the thickness of the liquid crystal layer 108 (20 μm to 100 μm). That is, the liquid crystal layer 108 is divided into a plurality of narrow liquid crystal cells sandwiched between the resin walls in a region sandwiched between the patch electrode 104 and the common electrode 106. The width of the second region 112 is preferably ⅕ to 1/15 of the thickness of the liquid crystal layer 108.

The response time of the liquid crystal is proportional to (t/d)² when the thickness of the liquid crystal layer is “t” and the width of the liquid crystal cell is “d”. Therefore, even when the liquid crystal layer 108 is thick, the response speed can be improved by reducing the width of the liquid crystal cell (corresponding to the first region 110) formed by the second region 112.

Since the liquid crystal layer 108 includes an ultraviolet curable monomer 1084, the second region 112 (that is, the resin wall) can be formed by irradiating ultraviolet rays from one or both sides of the first substrate 160 and the second substrate 162. The second region 112 is formed in a self-alignment manner in a region overlapping the first opening pattern 1042 and the second opening pattern 1062 by using the patch electrode 104 and the common electrode 106 as a photomask. That is, the patch electrode 104 is arranged with the first opening pattern 1042, the common electrode 106 is arranged with the second opening pattern 1062, and the liquid crystal layer 108 containing the ultraviolet curable monomer 1084 is irradiated with light, so that a liquid crystal cell having a narrow width sandwiched between the resin walls can be formed in a self-alignment manner.

The unit cell 102 shown in FIG. 1A and FIG. 1B has the structure in which the plurality of narrow liquid crystal cells is arranged in the region between the patch electrode 104 and the common electrode 106, so that the response speed can be improved. FIG. 1A shows an example in which the stripe-like first openings 1044 and the stripe-like second openings 1064 are arranged in parallel, although the stripe-like first openings 1044 and the stripe-like second openings 1064 may be arranged to intersect (orthogonal).

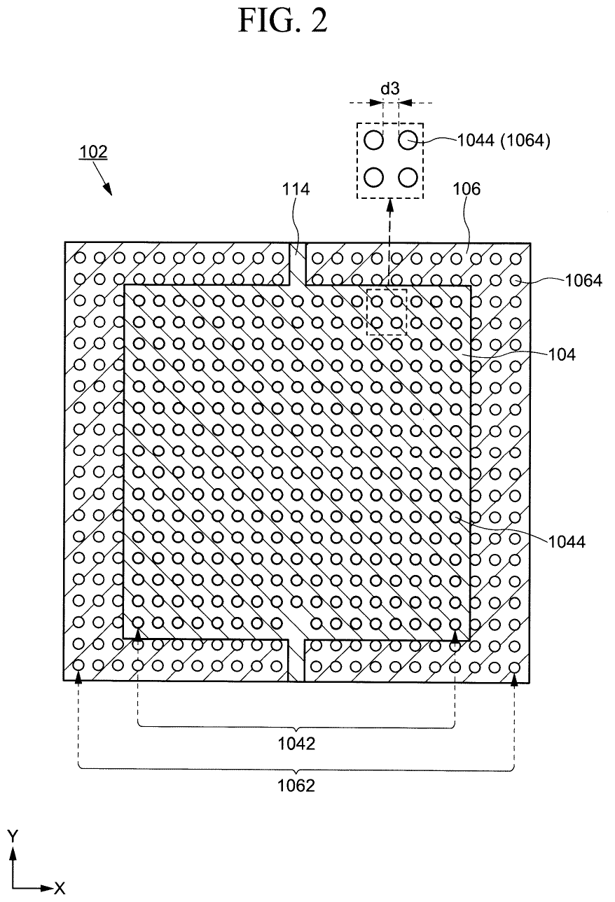

FIG. 2 shows an aspect in which the first opening pattern 1042 and the second opening pattern 1062 are formed of dot-like openings. The first opening pattern 1042 is formed of a plurality of dot-like first openings 1044, and the second opening pattern 1062 is formed of a plurality of dot-like second openings 1064. The plurality of dot-like first openings 1044 and the plurality of dot-like second openings 1064 are arranged to overlap in a plan view.

The second region 112 similar to that shown in FIG. 1B is formed in a region where the plurality of dot-like first openings 1044 and the plurality of dot-like second openings 1064 overlap. The first region 110 similar to that shown in FIG. 1B is formed in regions other than the regions where the plurality of dot-like first openings 1044 and the plurality of dot-like second openings 1064 overlap. The second region 112 is discontinuous, and the second region 112 is formed in a columnar shape between the patch electrode 104 and the common electrode 106. In other words, a plurality of resin columns is formed between the patch electrode 104 and the common electrode 106.

The dot-like first openings 1044 and dot-like second openings 1064 have a diameter of about 3 μm to 10 μm, for example, 5 μm. As shown in the inserted enlarged view of FIG. 2, the plurality of dot-like first openings 1044 and the plurality of dot-like second openings 1064 are evenly spaced d3. The liquid crystal layer 108 has a structure in which the first region 110 surrounds a plurality of second regions 112 (resin columns). In other words, the liquid crystal layer 108 has a structure in which a plurality of second regions 112 (resin columns) are arranged at equal intervals in the first region 110. The distance between the plurality of second regions 112 (resin columns) is sufficiently small with respect to the thickness (20 μm to 100 μm) of the liquid crystal layer 108. That is, the liquid crystal layer 108 has a narrow region sandwiched between the second regions 112 (resin columns). With this structure, the response speed can be improved even when the thickness of the liquid crystal layer 108 is large. The distance d3 between the second regions 112 (resin columns) is preferably ⅕ to 1/15 of the thickness of the liquid crystal layer 108.

The unit cell 102 shown in FIG. 2 can improve response speed by providing the columnar structure that sandwiches the liquid crystal at the narrow intervals described above in the region between the patch electrode 104 and the common electrode 106.

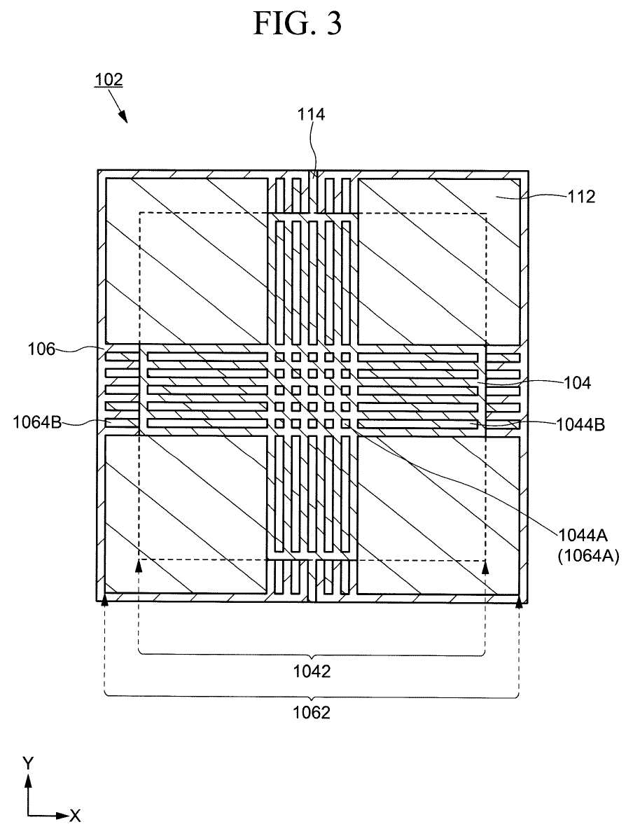

FIG. 3 shows the patch electrode 104 having a cross-shaped pattern in a planar view and a center portion of the cross-shaped pattern with a plurality of dot-like first openings 1044A and a plurality of stripe-like first openings 1044B extending outward from the center portion. The common electrode 106 has a cross-shaped pattern in a plan view and has a structure with a plurality of dot-like second openings 1064A and a plurality of stripe-like second openings 1064B extending outward from the center portion of the cross-shaped pattern in the center portion of the cross-shaped pattern. The dot-like first openings 1044A and the dot-like second openings 1064A are arranged to overlap, and the stripe-like first openings 1044B and the stripe-like second openings 1046B are arranged to overlap.

The unit cell 102 shown in FIG. 3 also has the first region 110 as shown in FIG. 1B in the region where the patch electrode 104 and the common electrode 106 overlap, the second region 112 as shown in FIG. 1B is formed in the region where the dot-like first openings 1044A and the dot-like second openings 1064A overlap and the stripe-like first openings 1044B and the stripe-like second openings 1046B overlap. The second region 112 is also formed in the region outside the cross-shaped patch electrode 104 and the common electrode 106 (the region surrounding the cross-shaped pattern).

With this configuration, the first region 110 in which the liquid crystal molecules 1082 are aligned is formed in the liquid crystal layer 108, and the first region 110 is sandwiched between the second region 112 formed by polymerization of the UV-curable monomer 1084. A plurality of first regions 110 and a plurality of second regions 112 are formed, and the plurality of first regions 110 are sandwiched between the plurality of second regions 112 (resin columns). The width of the first region 110 is preferably ⅕ to 1/15 of the length of the liquid crystal layer 108 relative to the thickness of the liquid crystal layer 108, as described above.

The unit cell 102 shown in FIG. 3 can also form a structure with a plurality of narrow liquid crystal cells in the region sandwiched between the patch electrode 104 and the common electrode 106, which can improve the response speed of the liquid crystal.

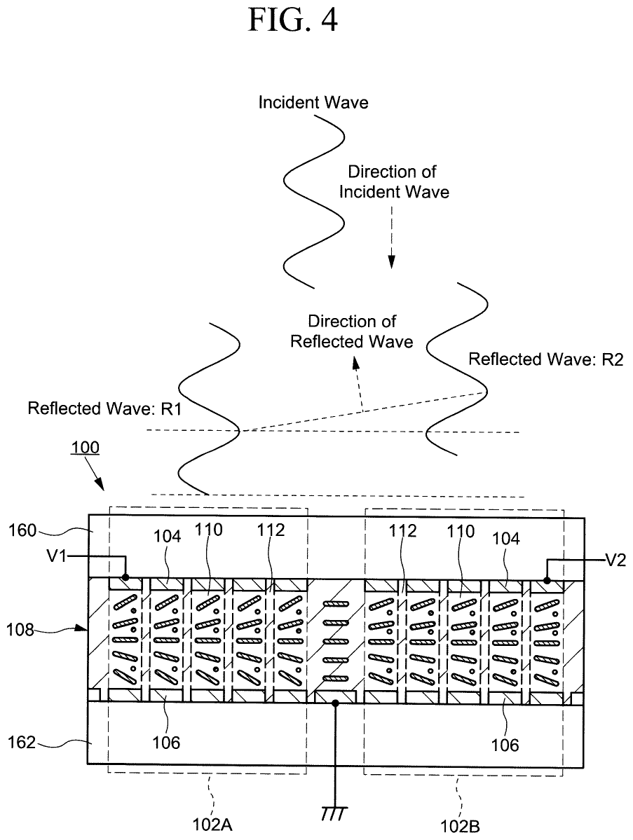

FIG. 4 shows a cross-sectional schematic view illustrating the operation of the reflecting element 100 according to the present embodiment. FIG. 4 shows the first unit cell 102A and the second unit cell 102B, which configures the reflecting element 100. The radio waves are incident on the first substrate 160 side of the reflecting element 100. The first unit cell 102A and the second unit cell 102B are arranged with the patch electrode 104 on the first substrate 160 and the common electrode 106 on the second substrate 162 across the liquid crystal layer 108.

The radio waves are incident on the first unit cell 102A and the second unit cell 102B at the same phase. A first level control voltage V1 is applied to the patch electrode 104 of the first unit cell 102A, and a second level control voltage V2 is applied to the patch electrode 104 of the second unit cell 102B. Here, the first level control voltage V1 and the second level control voltage V2 shall be different voltages (V1≠V2). The control voltage refers to the voltage applied to the liquid crystal layer 108.

Since the patch electrode 104 and the common electrode 106 are formed of metal, the radio waves incident from the first substrate 160 side are reflected. A phase of the reflected waves can be delayed by controlling the dielectric constant of the liquid crystal layer 108 that configures the unit cell 102. FIG. 4 shows a case in which the second unit cell 102B is applied to the second level control voltage V2 and the first unit cell 102A is applied to the first level control voltage V1, and in this case the phase of the unit cell 102A is delayed. As a result, the phase of the reflected wave R1 reflected in the first unit cell 102A and the phase of the reflected wave R2 reflected in the second unit cell 102B are different (FIG. 4 shows that the phase of the reflected wave R1 is delayed compared to the phase of the reflected wave R2), resulting in the reflected wave traveling in a diagonal direction. Thus, the reflecting element 100 has the function of controlling the reflected radio waves in the desired direction by arranging the plurality of unit cells 102 and controlling the voltage applied to the liquid crystal layer 108 for each unit cell 102.

As a control voltage applied to the first unit cell 102A and the second unit cell 102B, a polarity inversion voltage in which the polarity is periodically inverted is applied to prevent deterioration of the liquid crystal. FIG. 4 shows an example in which the common electrode 106 is grounded, however, a common inversion drive used in liquid crystal panels may be applied instead. That is, a common voltage with the same polarity and varying voltage level may be applied to the common electrode 106, and a control voltage with an inverted voltage level synchronized with the common voltage may be applied to the patch electrode 104 of the first unit cell 102A and the second unit cell 102B.

Thus, even when the control voltage that periodically changes polarity or periodically changes voltage level is applied, the response speed of the liquid crystal can be increased by dividing the liquid crystal layer 108 into the first region 110 and the second region 112, so that the direction of reflection of radio waves can be controlled without any delay.

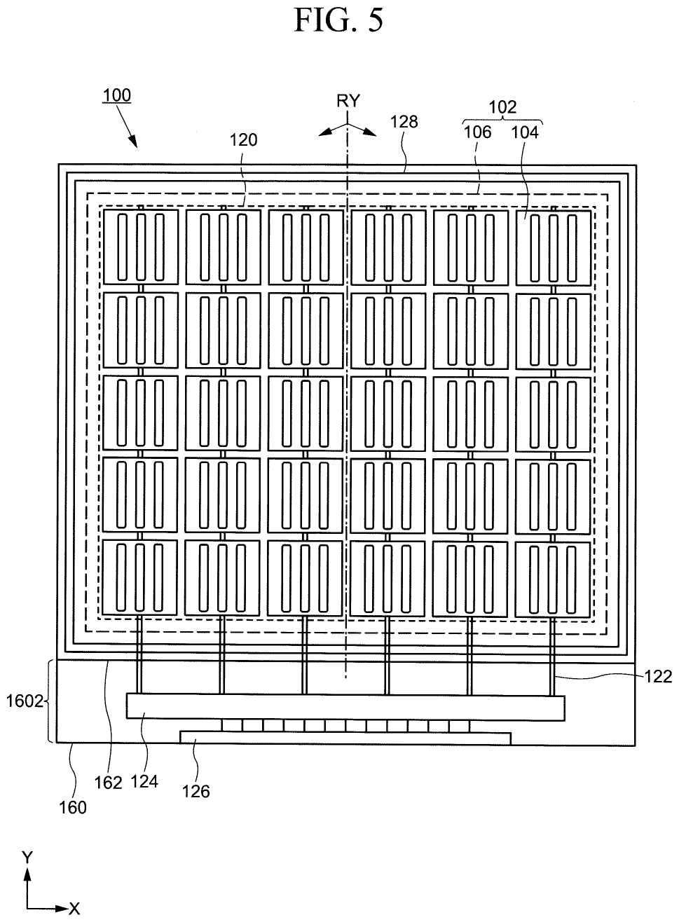

FIG. 5 shows an example of the reflecting element 100 according to the present embodiment. The reflecting element 100 has a structure in which the plurality of unit cells 102 are arranged in a matrix in the first direction (Y-axis direction) and the second direction (X-axis direction). The unit cell 102 includes the patch electrode 104, the common electrode 106, and the liquid crystal layer 108 (not shown in the figure). The patch electrode 104 of the unit cell 102 is arranged on the side of the incident surface of the radio wave. The first substrate 160 and the second substrate 162 are bonded by the sealant 128, and the liquid crystal layer 108 (not shown) is arranged in a region inside the sealant 128.

A reflecting surface 120 reflecting an incident radio wave is formed by the arrangement of the plurality of unit cells 102. The structure of the unit cell 102 is similar to that shown in FIG. 1A (or FIG. 2) and FIG. 1B, and the liquid crystal layer 108 in the region sandwiched between the patch electrode 104 and the common electrode 106 is divided into a plurality of liquid crystal cells.

The reflecting surface 120 is formed by arranging the plurality of unit cells 102. The reflecting element 100 has a peripheral region 1602 on which a driving circuit is installed in addition to the reflecting surface 120. A first driving circuit 124 and a terminal 126 are arranged in the peripheral region 1602. The first drive circuit 124 outputs a control signal to the patch electrode 104. The terminal 126 is a region for forming a connection with an external circuit, and a flexible printed circuit board (not shown) is connected, for example. A signal for controlling the first driving circuit 124 is input to the terminal 126.

FIG. 5 shows the unit cells 102 arranged in the first direction (Y-axis direction) connected in series by a first wiring 122 extending in the first direction (Y-axis direction). The reflecting surface 120 is arranged in the second direction (X-axis direction) with a patch electrode array formed by connecting the plurality of patch electrodes 104 arranged in the first direction (Y-axis direction) with the first wiring 122. The first wiring 122 is connected to the first driving circuit 124. The first drive circuit 124 outputs a control signal to the first wiring 122. The first drive circuit 124 outputs control signals of the same or different voltage levels to each first wiring 122. As a result, the control signal of the same or different voltage level is applied to each of the plurality of patch electrodes 104 arranged in the first direction (Y-axis direction).

The reflecting element 100 shown in FIG. 5 is applied with the control signal to each set of patch electrodes 104 arranged in the first direction (Y-axis direction), thereby controlling the reflection direction of the reflected wave of the radio wave incident on the reflecting surface 120. That is, the reflecting element 100 shown in FIG. 5 can control the traveling direction of the reflected wave incident on the reflecting surface 120 in the left-right direction of the drawing about the reflecting axis VR parallel to the first direction (Y-axis direction).

Since the liquid crystal layer 108 of each unit cell 102 is divided into the first region 110 and the second region 112, it is possible to increase the response speed of the liquid crystal and to control the reflection direction of radio waves without delay, in the reflecting element 100.

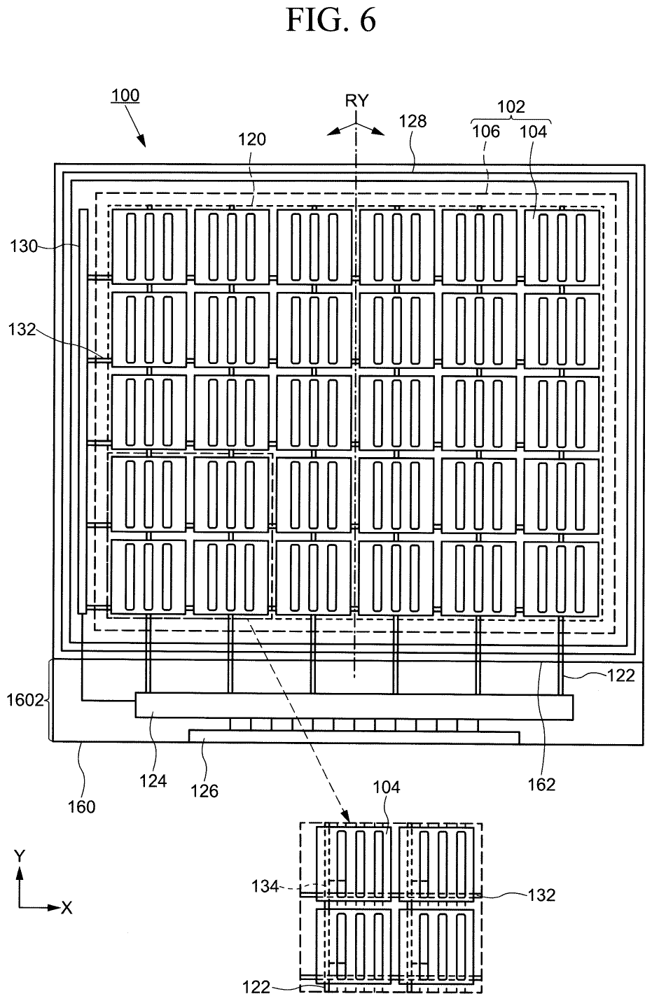

FIG. 6 shows another example of the reflecting element 100 according to the present embodiment. The following description will focus on the parts different from the reflecting element 100 shown in FIG. 5.

The reflecting element 100 shown in FIG. 6 includes a plurality of first wirings 122 extending in the first direction (Y-axis direction) and a plurality of second wirings 132 extending in the second direction (X-axis direction) to the reflecting surface 120. The plurality of first wirings 122 and the plurality of second wirings 132 are arranged to intersect an insulating layer (not shown). The plurality of first wirings 122 are connected to the first drive circuit 124, and the plurality of second wirings 132 are connected to the second drive circuit 130. The first driving circuit 124 outputs a control signal, and the second driving circuit 130 outputs a scanning signal.

FIG. 6 is an enlarged view showing the arrangement of four patch electrodes 104 and the first wiring 122 and the second wiring 132. A switching element 134 is arranged on each of the four patch electrodes 104. The switching (on and off) of the switching element 134 is controlled by the scanning signal applied to the second wiring 132. When the switching element 134 is turned on, the first wiring 122 and the patch electrode 104 are conductive, and a control signal is applied from the first wiring 122 to the patch electrode 104. The switching element 134 is formed of, for example, a thin film transistor. With this configuration, it is possible to select the plurality of patch electrodes 104 arranged in the second direction (X-axis direction) for each row and apply control signals of different voltage levels to each row.

The reflecting element 100 shown in FIG. 6 is capable of controlling the traveling direction of the reflected wave applied to the reflecting surface 120 in the left-right direction of the drawing about the reflecting axis VR parallel to the first direction (Y-axis direction), and is also capable of controlling the traveling direction of the reflected wave in the vertical direction of the drawing about the reflecting axis HR parallel to the second direction (X-axis direction). That is, since the reflecting element 100 shown in FIG. 6 has a reflection axis VR parallel to the first direction (Y-axis direction) and a reflection axis VH parallel to the second direction (X-axis direction), the reflection angle can be controlled obliquely upward and obliquely downward by using the reflection axis VR as the rotation axis, the reflection axis HR as the rotation axis, and the reflection axis VR and the reflection axis HR.

The reflecting element 100 shown in FIG. 6 also makes it possible to increase the response speed of the liquid crystal and control the reflection direction of the radio waves without delay since the liquid crystal layer 108 of each unit cell 102 is divided into a first region 110 and a second region 112.

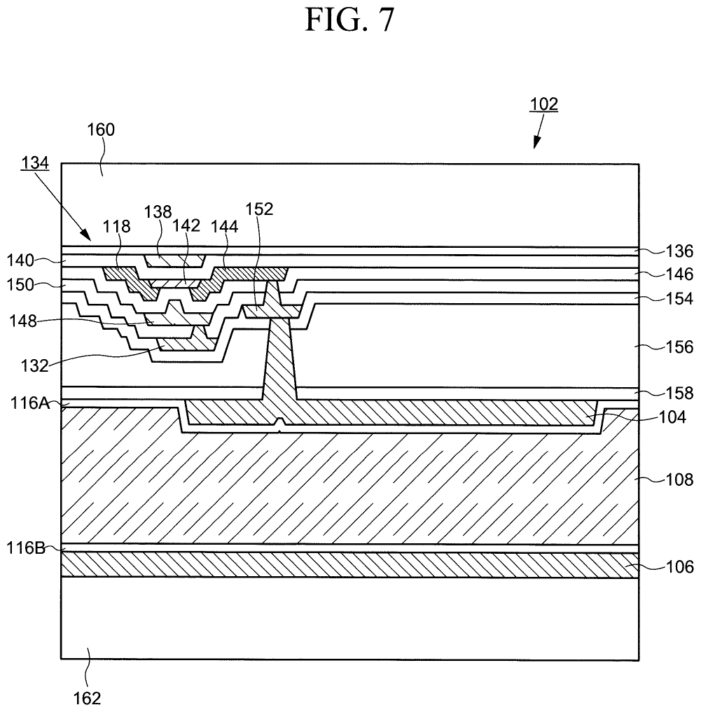

FIG. 7 shows an example of the cross-sectional structure of the unit cell 102 in which the switching element 134 is connected to the patch electrode 104. The switching element 134 is arranged on the first substrate 160. The switching element 134 is formed of a thin film transistor. The switching element 134 has a structure in which a first gate electrode 138, a first gate insulating layer 140, a semiconductor layer 142, a second gate insulating layer 146, and a second gate electrode 148 are laminated. An undercoat layer 136 is also arranged between the first gate electrode 138 and the first substrate 160. The first wiring 122 is arranged between the first gate insulating layer 140 and the second gate insulating layer 146. The first wiring 122 is arranged to be in contact with the semiconductor layer 142. The first connection wiring 144 is arranged in the same layer as the conductive layer forming the first wiring 122. The first connection wiring 144 is arranged to be in contact with the semiconductor layer 142. The first wiring 122 and the first connecting wiring 144 are connected to portions corresponding to input/output terminals (portions corresponding to source and drain) of the switching element 134.

A first interlayer insulating layer 150 is arranged to cover the switching element 134. The second wiring 132 is arranged on the first interlayer insulating layer 150. The second wiring 132 is connected to the second gate electrode 148 through a contact hole formed in the first interlayer insulating layer 150. Although not shown, the first gate electrode 138 and the second gate electrode 148 are electrically connected to each other in a region not overlapping the semiconductor layer 142. A second connecting wiring 152 is arranged on the first interlayer insulating layer 150 with the same conductive layer as the second wiring 132. The second connection wiring 152 is connected to the first connection wiring 144 through a contact hole formed in the first interlayer insulating layer 150.

A second interlayer insulating layer 154 is arranged to cover the second wiring 132 and the second connecting wiring 152. Further, a planarizing layer 156 is arranged to fill the step of the switching element 134. It is possible to form the patch electrode 104 having a flat surface without being affected by the arrangement of the switching elements 134 by providing the planarizing layer 156. A passivation layer 158 is arranged on the planarizing layer 156. The patch electrode 104 is arranged on the passivation layer 158. The patch electrode 104 is connected to the second connection wiring 152 through a contact hole through the passivation layer 158, the planarizing layer 156, and the second interlayer insulating layer 154. A first alignment film 116A is arranged on the patch electrode 104.

The common electrode 106 is arranged on the second substrate 162 as shown in FIG. 1B. A second alignment film 116B is arranged on the common electrode 106. The first substrate 160 and the second substrate 162 are arranged so that the patch electrode 104 and the common electrode 106 face inward and face each other. The patch electrode 104 and the common electrode 106 are arranged apart from each other, and a liquid crystal layer 108 is arranged in the separated region.

Each layer formed on the first substrate 160 is formed using the following materials. The undercoat layer 136 is formed of, for example, a silicon oxide film. The first gate insulating layer 140 and the second gate insulating layer 146 are formed of, for example, a silicon oxide film or a laminated structure of a silicon oxide film and a silicon nitride film. The semiconductor layer 142 is formed of an oxide semiconductor including a silicon semiconductor such as amorphous silicon, polycrystalline silicon, and metal oxides such as indium oxide, zinc oxide, and gallium oxide. The first gate electrode 138 and the second gate electrode 148 may be formed of, for example, molybdenum (Mo), tungsten (W), or an alloy thereof. The first wiring 122, the second wiring 132, the first connecting wiring 144, and the second connecting wiring 152 are formed of a metal material such as titanium (Ti), aluminum (Al), and molybdenum (Mo). These wirings may be formed of, for example, a laminated structure of titanium (Ti)/aluminum (Al)/titanium (Ti) or a laminated structure of molybdenum (Mo)/aluminum (Al)/molybdenum (Mo). The planarizing layer 156 is formed of a resin material such as acrylic or polyimide. The passivation layer 158 is formed of, for example, a silicon nitride film. The patch electrode 104 and the common electrode 106 are formed of a metal film such as aluminum (Al) and copper (Cu) and a transparent conductive film such as indium tin oxide (ITO).

The patch electrode 104 and the common electrode 106 have a structure shown in FIG. 1A and a structure shown in FIG. 2 in a plan view.

As shown in FIG. 7, the second wiring 132 is connected to the gate of the transistor used as the switching element 134, the first wiring 122 is connected to one of the source and drain of the transistor, and the patch electrode 104 is connected to the other of the source and drain, whereby a predetermined patch electrode can be selected from among a plurality of patch electrodes 104 arranged in a matrix shape to apply a control signal. It is possible to apply the control voltage to each of the patch electrodes 104 arranged in a vertical line along the first direction (Y-axis direction) or to each of the patch electrodes 104 arranged in a horizontal line along the second direction (X-axis direction), by providing the switching element 134 on individual patch electrodes 104 in the reflecting surface 120. For example, when the reflecting surface 120 is upright, the reflecting direction of the reflected wave can be freely controlled in the lateral, vertical, oblique upward, and oblique downward directions. In this case, the reflecting element 100 can increase the response speed of the liquid crystal by dividing the liquid crystal layer 108 of each unit cell 102 into the first region 110 and the second region 112 and can control the reflection direction of the radio wave without delay.

The various configurations of the reflecting element of the intelligent reflecting surface illustrated as an embodiment of the present invention can be suitably combined as long as they do not contradict each other. Based on the reflecting elements disclosed herein and in the drawings, additions, deletions, or design changes made by a person skilled in the art as appropriate, or additions, omissions, or changes in conditions of steps are also within the scope of the present invention as long as they have the gist of the present invention.

Any other advantageous effect that is different from the advantageous effect provided by the embodiments disclosed herein, which is apparent from the description herein or can be easily predicted by those skilled in the art, will naturally be construed to be provided by the invention.

What is claimed is:

1. A reflecting element for intelligent reflecting surface, the reflecting element comprising:
a patch electrode including a first opening pattern;
a common electrode opposed to and spaced apart from the patch electrode and including a second opening pattern; and
a liquid crystal layer arranged between the patch electrode and the common electrode and containing a liquid crystal molecule and an ultraviolet curable monomer,
wherein the first opening pattern overlaps the second opening pattern in a plan view,
wherein the liquid crystal layer includes:
a first region including the liquid crystal molecule and the ultraviolet curable monomer; and
a second region including the liquid crystal molecule in a resin polymerized and solidified with the ultraviolet curable monomer.

2. The reflecting element according to claim 1, wherein the first opening pattern includes a plurality of stripe-like first openings, and the second opening pattern includes a plurality of stripe-like second openings, and
the plurality of stripe-like first openings and the plurality of stripe-like second openings overlap.

3. The reflecting element according to claim 2, wherein the plurality of stripe-like first openings is arranged side by side at regular intervals,
the plurality of stripe-like second openings is arranged side by side at regular intervals, and
the second region includes a plurality of second regions, and the plurality of second regions are spaced apart and arranged at regular intervals.

4. The reflecting element according to claim 3, wherein the first region includes a plurality of first regions, and the plurality of first regions are sandwiched between the plurality of second regions.

5. The reflecting element according to claim 4, wherein a width of each of the plurality of second regions has a length of ⅕ to 1/15 with respect to a thickness of the liquid crystal layer.

6. The reflecting element according to claim 4, wherein the plurality of second regions forms a plurality of resin walls, and
the plurality of first regions is sandwiched between the plurality of resin walls.

7. The reflecting element according to claim 1, wherein the first opening pattern includes a plurality of dot-like first openings, the second opening pattern includes a plurality of dot-like second openings, and
the plurality of dot-like first openings and the plurality of dot-like second openings overlap.

8. The reflecting element according to claim 7, wherein the plurality of dot-like first openings is arranged side by side at regular intervals,
the plurality of dot-like second openings is arranged side by side at regular intervals, and
the second region includes a plurality of second regions, and the plurality of second regions are spaced apart and arranged at regular intervals.

9. The reflecting element according to claim 8, wherein the first region surrounds the plurality of second regions in the liquid crystal layer.

10. The reflecting element according to claim 9, wherein a spacing apart from each of the plurality of second regions has a length of ⅕ to 1/15 with respect to a thickness of the liquid crystal layer.

11. The reflecting element according to claim 9, wherein the plurality of second regions forms a plurality of resin columns, and
the plurality of resin columns is arranged in the first region.

12. The reflecting element according to claim 1, wherein the patch electrode has a first cross-shaped pattern in a plan view,
the first opening pattern includes a plurality of dot-like first openings arranged in a center portion of the first cross-shaped pattern, and a plurality of stripe-like first openings extending outwardly from the center portion and arranged adjacent to the plurality of dot-like first openings,
the common electrode has a second cross-shaped pattern in a plan view,
the second opening pattern includes a plurality of dot-like second openings arranged in a center portion of the second cross-shaped pattern, and a plurality of stripe-like second openings extending outwardly from the center portion and arranged adjacent to the plurality of dot-like second openings, and
the second region is formed in a region where the plurality of dot-like first openings and the plurality of dot-like second openings overlap in a plan view, and the plurality of strip-like first openings and the plurality of strip-like second openings overlap in a plan view.

13. The reflecting element according to claim 12, wherein the plurality of dot-like first openings is arranged side by side at regular intervals,
the plurality of dot-like second openings is arranged side by side at regular intervals, and
the second region includes a plurality of second regions, and the plurality of second regions are spaced apart and arranged at regular intervals.

14. The reflecting element according to claim 13, wherein the first region includes a plurality of first regions, and the plurality of first regions are sandwiched between the plurality of second regions.

15. The reflecting element according to claim 14, wherein a width of each of the plurality of second regions has a length of ⅕ to 1/15 with respect to a thickness of the liquid crystal layer.

16. The reflecting element according to claim 15, wherein the plurality of second regions forms a plurality of resin columns, and
the plurality of first regions is sandwiched between the plurality of resin columns.

17. The reflecting element according to claim 1, wherein the patch electrode is arranged on an incident surface side of a radio wave, and the common electrode is arranged on a back surface side of the patch electrode across the liquid crystal layer.
